(19) United States
(12) Patent Application Publication
(10) Pub. No.: US 2012/0066359 A1
(43) Pub. Date: Mar. 15, 2012

(54) METHOD AND SYSTEM FOR EVALUATING LINK-HOSTING WEBPAGES

(76) Inventors: Erik S. Freeman, Van Nuys, CA (US); Carl A. Dunham, Wakefield, RI (US); Autumn Francesca, Wakefield, RI (US); Richard Egan, Redondo Beach, CA (US); Patrick S. Wynne, Warwick, RI (US); David Counts, Providence, RI (US); Edward M. Ives, Exeter, RI (US); Bradd Libby, Hope Valley, RI (US)

(21) Appl. No.: 12/878,490

(22) Filed: Sep. 9, 2010

(51) Int. Cl. G06F 15/173

(52) U.S. Cl. 709/223

(57) ABSTRACT

A method for valuing a link-hosting webpage is provided. The method includes the act of receiving, on a computer system, at least one keyword. The method also includes the act of receiving, on a computer system, at least one identifier of a webpage, the webpage having been previously identified as a link-hosting webpage. The method also includes the act of accessing information about the webpage over a computer network. The method also includes the act of determining an importance of the webpage based on the at least one keyword and the information about the webpage. The method also includes the act of displaying the importance on a computer-based user interface.

### FIELD OF THE INVENTION

The present invention is directed to online advertising.

### DISCUSSION OF RELATED ART

Search engines, such as those offered by Google, Inc. (Mountain View, Calif.) and the Microsoft Corporation (Redmond, Wash.), among others, provide a list of relevant webpages in response to keyword searches. Search engines may use several factors to determine the relevance of a particular webpage to a particular search. Some factors may be based on links from third-party webpages to that particular webpage. The presence of these links may increase the importance attributed to the linked webpage by a search engine, which in turn may cause the search engine to display the linked webpage higher in a list of search results. Search engines may assign a higher importance to a link from a trusted or high-quality third party webpage, and may assign a lower importance to a link from an unknown or lower-quality third party webpage. However, the algorithms used in many popular search engines are protected as trade secrets, and many of the details of their operation are not publicly known.

Google's PageRank® is an example of a system for attributing importance to a webpage based on third-party links to that webpage. However, this and similar systems are keyword-independent, in that they determine the importance of a third-party webpage without regard to any keyword. The drawback of such an approach is that a third-party webpage may contain content that is highly relevant for some topics, while being irrelevant to other topics.

Other systems in the art, such as the AdMax™ content analysis tool offered by the Search Agency of Santa Monica, Calif., may estimate the importance attributed to a webpage by a search engine for a given keyword. However, such systems simply examine the webpage for occurrences and placement of the keyword and recommend ways to optimize the webpage to improve its search engine ranking for that keyword. There is at present no system that analyzes webpages with respect to search terms to assess the desirability of placing links on the webpages.

### SUMMARY

Marketers seeking to drive traffic to a webpage may wish to increase the importance attributed to the webpage by arranging for hyperlinks to the webpage to be placed on third-party webpages. It would be useful to estimate the value of those links in order to prioritize efforts to acquire them. Marketers also often obtain links as part of coordinated linking campaigns. Examples include email requests, article submissions, or postings on social media sites. These campaigns often require significant manual effort, and it would be useful to estimate the value of potential links before expending resources on attempts to obtain them.

One measure of the value of a link on a link-hosting webpage is the position the link-hosting webpage will appear in the results of a search engine search on one or more keywords of interest. Thus, it may be useful to predict or estimate the factors taken into consideration by a search engine in ordering the results of a search. By assessing the link-hosting webpage according to those factors, the relative ranking of the link-hosting webpage by the search engine may be predicted, and the value of a link on the link-hosting webpage can be more accurately determined or approximated.

According to one aspect of the present invention, a system and method are provided for receiving a keyword and at least one identifier of a webpage, such as a domain name or URL. Information about the webpage may be determined from the webpage itself, from third party databases, and from domain registration databases. This information is used, in conjunction with the keyword, to determine several measurements of the importance of the webpage. For example, it may be possible to predict the importance that would be attributed to the webpage by a search engine performing a search on the keyword. By determining the importance, it may be possible to use that importance to estimate the value of a link on the webpage with respect to searches on a particular keyword. In some embodiments, a stemming algorithm may be used to reduce both the keyword and words on the webpage to their stems. This would allow variants of the keyword (e.g., plural/singular, or past/present/future tense) to be recognized in the content of the webpage, thereby increasing the accuracy of the importance estimate.

According to one aspect of the present invention, a method for valuing a link-hosting webpage is provided. The method includes an act of receiving, on a computer system, at least one keyword. The method also includes an act of receiving, on a computer system, at least one identifier of a webpage, the webpage having been previously identified as a link-hosting webpage. The method also includes an act of accessing information about the webpage over a computer network. The method also includes an act of determining an importance of the webpage based on the at least one keyword and the information about the webpage. The method also includes an act of displaying the importance on a computer-based user interface.

According to one embodiment, the acts of receiving, on the computer system, the at least one keyword and the at least one identifier of the webpage includes an act of receiving user input from a user through a computer-based user interface.

According to another embodiment, the act of accessing information about the webpage over the computer network includes an act of accessing, through an application programming interface, information about the webpage from a third party database.

According to still another embodiment, the act of determining the importance of the webpage based on the at least one keyword and the information about the webpage includes an act of counting a number of occurrences of the at least one keyword on the webpage.

According to a further embodiment, the act of determining the importance of the webpage based on the at least one keyword and the information about the webpage further comprises acts of reducing each of the at least one keywords to a first word stem, identifying at least one word within the webpage, reducing the at least one word to a second word stem, and, responsive to the first word stem and the second word stem being substantially identical, identifying the second word stem as an occurrence of the at least one keyword.

According to yet a further embodiment, the act of determining the importance of the webpage based on the at least one keyword and the information about the webpage includes an act of identifying a number of occurrences of the at least one keyword within a title tag on the webpage.

According to another embodiment, the act of accessing information about the webpage over a computer network includes an act of accessing registration information about a domain where the webpage is hosted.

According to still another embodiment, the act of determining the importance of the webpage based on the at least one keyword and the information about the webpage includes an act of generating a quantitative importance score for the webpage.

According to another embodiment, the act of determining the importance of the webpage based on the at least one keyword and the information about the webpage includes an act of estimating a value of a link on the webpage.

According to a further embodiment, the value of the link is calculated based on the similarity of the candidate webpage to at least one host webpage that has hosted another link, where the value of the another link is known.

According to a further embodiment, the value of the link is a numerical score.

According to a further embodiment, the value of the link is a dollar value.

According to another embodiment, the act of receiving, on a computer system, at least one identifier of a webpage comprises the act of receiving a first identifier of a first webpage and a second identifier of a second webpage. The method further comprises acts of accessing information about the first webpage and the second webpage over the computer network, determining a comparative importance of the first webpage and the second webpage based on the at least one keyword and the information about the first webpage and the second webpage, and displaying the comparative importance on the computer-based user interface.

According to still another embodiment, the method further comprises an act of receiving, on a computer system, at least one identifier of a competitor webpage, wherein the act of accessing information about the webpage over the computer network includes the act of comparing the at least one identifier of the competitor webpage to the at least one identifier of the webpage. The act of accessing information about the webpage over a computer network is performed responsive to the at least one identifier of the competitor webpage not matching the at least one identifier of the webpage.

According to yet another embodiment, the act of determining the importance of the webpage based on the at least one keyword and the information about the webpage includes an act of identifying a number of occurrences of the at least one keyword within a URL of the webpage.

According to another embodiment, the act of determining the importance of the webpage based on the at least one keyword and the information about the webpage includes an act of identifying a number of different media formats on the webpage.

According to still another embodiment, the act of determining the importance of the webpage based on the at least one keyword and the information about the webpage includes an act of determining an amount of time that has elapsed since the webpage was last changed.

According to yet another embodiment, the method further comprises acts of receiving, on a computer system, at least one blacklist keyword, the at least one blacklist keyword having been previously associated with a low importance; and counting a number of occurrences of the at least one blacklist keyword on the webpage. The act of determining the importance of the webpage based on the at least one keyword and the information about the webpage includes an act of identifying a number of occurrences of the at least one blacklisted keyword on the webpage.

According to another embodiment, the act of determining the importance of the webpage based on the at least one keyword and the information about the webpage includes an act of identifying a reading level of textual content on the webpage.

According to still another embodiment, the act of determining the importance of the webpage based on the at least one keyword and the information about the webpage includes acts of identifying at least one content topic on the webpage, and, for each content topic, determining whether the content topic is relevant to the keyword.

According to yet another embodiment, the act of determining the importance of the webpage based on the at least one keyword and the information about the webpage includes an act of identifying advertisements on the webpage.

According to another embodiment, the act of determining the importance of the webpage based on the at least one keyword and the information about the webpage includes an act of identifying a category substring within a URL of the webpage, the category substring identifying a category for the website.

According to still another embodiment, the act of determining the importance of the webpage based on the at least one keyword and the information about the webpage includes an act of identifying a category substring within the webpage, the category substring identifying a category for the website.

According to yet another embodiment, the act of determining the importance of the webpage based on the at least one keyword and the information about the webpage includes an act of determining a duration of time for which a domain name of the webpage has been registered.

According to another embodiment, the act of determining the importance of the webpage based on the at least one keyword and the information about the webpage includes an act of determining a term for which a domain name of the webpage has been registered.

According to still another embodiment, the method further comprises an act of identifying in the webpage a telephone number associated with the webpage.

According to yet another embodiment, the method further comprises an act of identifying in the webpage an email address associated with the webpage.

According to another embodiment, the webpage is a first webpage, further comprising acts of identifying a press release webpage that contains hyperlinks to at least one press release, and identifying, on the press release webpage, a hyperlink to a press release associated with the first webpage.

According to another embodiment, the act of determining the importance of the webpage based on the at least one keyword and the information about the webpage includes an act of determining a prominence of the at least one keyword within the content of the webpage.

According to a further embodiment, the act of determining the prominence of the at least one keyword is determined with reference to a term frequency-inverse document frequency.

According to yet a further embodiment, the prominence is determined through latent semantic analysis.

According to yet a further embodiment, the prominence is determined through latent Dirichlet allocation.

According to another embodiment, the act of determining the importance of the webpage based on the at least one keyword and the information about the webpage includes an act of identifying a number of occurrences of the at least one keyword in an HTML tag.

According to a further embodiment, the HTML tag is a title tag.

According to a further embodiment, the HTML tag is a meta description tag.

According to a further embodiment, the HTML tag is an image ALT tag.

According to another aspect of the present invention, a method for evaluating the importance of a link-hosting webpage is provided. The method includes an act of receiving, on a computer system, at least one keyword. The method also includes an act of receiving, on a computer system, at least one identifier of a webpage. The method also includes an act of accessing information about the webpage over a computer network. The method also includes an act of predicting, based on the at least one keyword and the information about the webpage, an importance that would be attributed to the webpage by a search engine performing a search on the at least one keyword. The method also includes an act of displaying the importance on a computer-based user interface.

According to yet another aspect of the present invention, a system is provided. The system includes a user interface configured to receive at least one keyword and an identifier of a webpage, and further configured to display an importance of the webpage. The system also includes a network interface configured to access information about the webpage over a computer network. The system also includes an importance engine configured to determining the importance of the webpage based on the at least one keyword and the information about the webpage.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example computer system upon which various aspects of the present invention may be implemented;

FIG. 2 shows an example system for valuing a link-hosting webpage in accordance with one embodiment of the invention;

FIG. 3 is a block diagram of the relationship between linked webpages in accordance with one embodiment of the invention;

FIG. 4 is a block diagram of an application programming interface in accordance with one embodiment of the invention;

FIG. 5 shows a user and a user interface in accordance with embodiments of the present invention;

FIG. 6 illustrates an example process for valuing a link-hosting webpage in accordance with one embodiment of the invention;

FIG. 7 shows an input interface in accordance with embodiments of the present invention; and

FIG. 8 shows a reporting interface in accordance with embodiments of the present invention.

### DETAILED DESCRIPTION

According to one aspect of the present invention, a system and method are provided for receiving a keyword and at least one identifier of a webpage, such as a domain name or URL. Information about the webpage may be determined from the webpage itself, from third party databases, and from domain registration databases. This information is used, in conjunction with the keyword, to determine several measurements of the importance of the webpage. For example, it may be possible to predict the importance that would be attributed to the webpage by a search engine performing a search on the keyword. By determining the importance, it may be possible to use that importance to estimate the value of a link on the webpage with respect to searches on a particular keyword. In this way, a marketer can estimate, for a given keyword search on a search engine, the value that would be realized from obtaining a link on a given webpage.

One or more of these features may be implemented on one or more computer systems coupled by a network (e.g., the Internet). Example systems upon which various aspects are implemented, as well as exemplary methods performed by those systems, are discussed in more detail below.

The aspects disclosed herein, which are consistent with principles of the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to evaluating link-hosting webpages. However, such a system may also perform other functions. Moreover, the systems described herein may be configured to include or exclude any of the functions discussed herein. Thus, the invention is not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

### Computer System

Various aspects and functions described herein in accord with the present invention may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the invention is not limited to any particular distributed architecture, network, or communication protocol. Furthermore, aspects in accord with the present invention may be implemented as specially-programmed hardware and/or software.

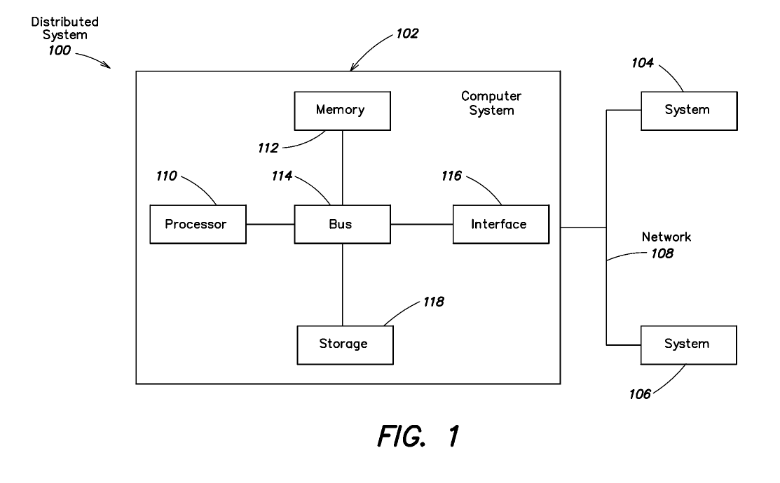

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106. As shown, the computer systems 102, 104 and 106 are interconnected by, and may exchange data through, a communication network 108. The network 108 may include any communication network through which computer systems may exchange data. To exchange data via the network 108, the computer systems 102, 104 and 106 and the network 108 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA BOP, RMI, DCOM and Web Services. To ensure data transfer is secure, the computer systems 102, 104 and 106 may transmit data via the network 108 using a variety of security measures including TSL, SSL or VPN, among other security techniques. While the distributed computer system 100 illustrates three networked computer systems, the distributed computer system 100 may include any number of computer systems, networked using any medium and communication protocol.

Various aspects and functions in accord with the present invention may be implemented as specialized hardware or software executing in one or more computer systems including the computer system 102 shown in FIG. 1. As depicted, the computer system 102 includes a processor 110, a memory 112, a bus 114, an interface 116 and a storage system 118. The processor 110, which may include one or more microprocessors or other types of controllers, can perform a series of instructions that manipulate data. The processor 110 may be a well-known, commercially available processor such as an Intel Pentium, Intel Atom, Motorola PowerPC, SGI MIPS, Sun UltraSPARC, or Hewlett-Packard PA-RISC processor, or may be any other type of processor or controller as many other processors and controllers are available. As shown, the processor 110 is connected to other system placements, including a memory 112, by the bus 114.

The memory 112 may be used for storing programs and data during operation of the computer system 102. Thus, the memory 112 may be a relatively high performance, volatile, random access memory such as a dynamic random access memory (DRAM) or static memory (SRAM). However, the memory 112 may include any device for storing data, such as a disk drive or other non-volatile storage device. Various embodiments in accord with the present invention can organize the memory 112 into particularized and, in some cases, unique structures to perform the aspects and functions disclosed herein.

Components of the computer system 102 may be coupled by an interconnection element such as the bus 114. The bus 114 may include one or more physical busses (for example, busses between components that are integrated within a same machine), and may include any communication coupling between system placements including specialized or standard computing bus technologies such as IDE, SCSI, PCI and InfiniBand. Thus, the bus 114 enables communications (for example, data and instructions) to be exchanged between system components of the computer system 102.

Computer system 102 also includes one or more interface devices 116 such as input devices, output devices and combination input/output devices. The interface devices 116 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 116 allow the computer system 102 to exchange information and communicate with external entities, such as users and other systems.

Storage system 118 may include a computer-readable and computer-writeable nonvolatile storage medium in which instructions are stored that define a program to be executed by the processor. The storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk or flash memory, among others. In operation, the processor 110 or some other controller may cause data to be read from the nonvolatile recording medium into another memory, such as the memory 112, that allows for faster access to the information by the processor 110 than does the storage medium included in the storage system 118. The memory may be located in the storage system 118 or in the memory 112. The processor 110 may manipulate the data within the memory 112, and then copy the data to the medium associated with the storage system 118 after processing is completed. A variety of components may manage data movement between the medium and the memory 112, and the invention is not limited thereto.

Further, the invention is not limited to a particular memory system or storage system. Although the computer system 102 is shown by way of example as one type of computer system upon which various aspects and functions in accord with the present invention may be practiced, aspects of the invention are not limited to being implemented on the computer system, shown in FIG. 1. Various aspects and functions in accord with the present invention may be practiced on one or more computers having different architectures or components than that shown in FIG. 1. For instance, the computer system 102 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 102 may include an operating system that manages at least a portion of the hardware placements included in computer system 102. A processor or controller, such as processor 110, may execute an operating system which may be, among others, a Windows-based operating system (for example, Windows NT, Windows 2000/ME, Windows XP, Windows 7, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing product, such as, for example, the Google search engine available from Google of Mountain View, Calif., the Yahoo search engine available from Yahoo! of Sunnyvale, Calif.; the Bing search engine available from Microsoft of Seattle Wash. Aspects of the system may be implemented on database management systems such as SQL Server available from Microsoft of Seattle, Wash.; Oracle Database from Oracle of Redwood Shores, California; and MySQL from Sun Microsystems of Santa Clara, Calif.; or integration software such as WebSphere middleware from IBM of Armonk, N.Y. However, a computer system running, for example, SQL Server may be able to support both aspects in accord with the present invention and databases for sundry applications not within the scope of the invention.

In addition, the method described herein may be incorporated into other hardware and/or software products, such as a web publishing product, a web browser, or an internet marketing or search engine optimization tool.

Example System Architecture

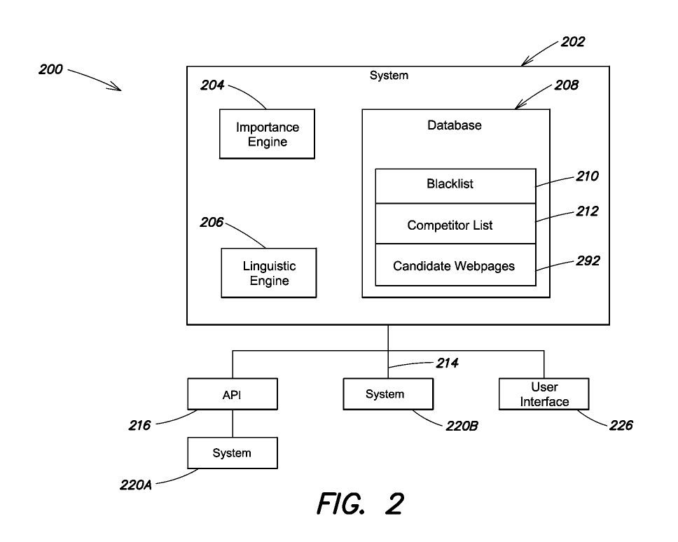

An example system in accordance with aspects of the invention can be seen in FIG. 2. The system 200 could be used by or on behalf of a marketer interested in determining an importance and/or value of a link placed on a webpage, the importance and/or value being determined with reference to a keyword search being performed on a search engine. As used herein, the term “marketer” refers to either a user of the system 200 or an entity on whose behalf the user is acting. The term “candidate webpage” as used herein refers to a webpage that is a candidate to provide a link to another webpage, which is referred to herein as a “linked webpage.”

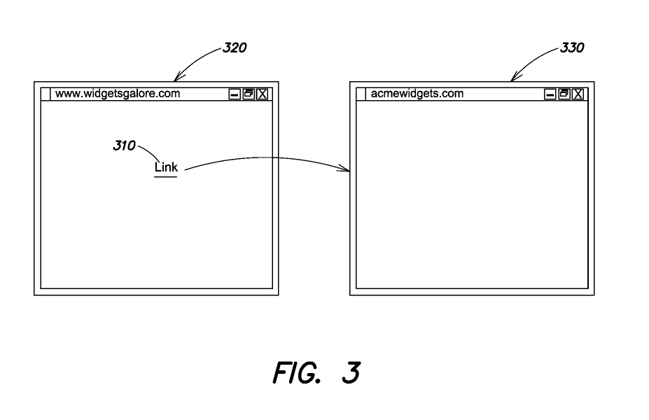

An example linking structure can be seen in FIG. 3. In the example, a link 310 has been successfully placed on candidate webpage 320, with the link pointing to linked webpage 330. To further illustrate the terminology, if a marketer arranged for a link to acmewidgets.com to be placed on the webpage widgetsgalore.com, then acmewidgets.com would be the linked webpage and widgetsgalore.com would be the candidate webpage. It will be appreciated that the relationship between the marketer and the linked webpage is largely unimportant to the present invention. For example, the linked webpage may belong to the marketer, or the marketer may simply be hired to arrange for the acquisition of links to the linked webpage.

As used herein, the “strength” of a candidate webpage refers to a quality measurement of the candidate webpage that is determined without reference to the keyword. For example, the strength of a candidate webpage may be determined with reference to the number of links on third party webpages that point to the candidate webpage, and the number of links that point to each of those third party webpages from other webpages. As described in more detail below, the strength may also be determined with reference to the content of the candidate webpage. For example, the content may be analyzed to identify the most recent date on which the candidate webpage was updated. The quality of the content of the candidate webpage or the presence of certain “blacklisted” words may also be determined.

As used herein, the “relevance” of a candidate webpage refers to the pertinence of the candidate webpage to a given keyword. For example, the relevance may be determined by identifying the number or placement of occurrences of the keyword on the candidate webpage.

As used herein, the “attaintability” of a candidate webpage refers to the feasibility and ease of placing a link on the candidate webpage. For example, it may be determined from the domain name (or top-level domain in which the domain is located) that the organization responsible for the candidate webpage is unlikely to be receptive to requests to place links on the webpage. The candidate webpage may also be examined to determine if the webpage links to a contact page, contains contact information, or otherwise indicates that the proper party to contact about placing a link may be identifiable.

As used herein, the “value” of a candidate webpage may refer to the predicted effort to place a link on the candidate webpage. Such effort may be determined, for example, by performing a regression analysis on information about already-acquired links. The value of a candidate webpage may also refer to the maximum effort that a marketer should expend for a link on a given candidate webpage. This maximum effort may be determined with reference to a return on investment (ROI) of some existing links or other indicator. Effort may include activities such as research, contacting organizations owning target pages, responding to organizations owning target pages, tracking efforts, and confirming that links have been placed. Effort may be measured in terms of time, such as man-hours or man-days, or in terms of cost in dollars or other currency, which may include the cost of the various effort activities as well as any other costs associated with obtaining or maintaining the link.

Returning to FIG. 2, the distributed system 200 includes a system 202. The system 202 includes a network interface 214 that is configured to access information about candidate webpages over a computer network. The system 202 includes an importance engine 204, which configured to determine an importance of a candidate webpage based on a keyword and information about the webpage. The system 202 also includes a database 208, which may store a blacklist 210 of keywords known or suspected to be assigned a low importance score by search engines. The database 208 may also store one or more identifiers of candidate webpages 292. The system 202 may include a linguistic engine 206, which is configured to identify words having similar linguistic properties or other relationships with a keyword entered by the user. The distributed system 200 may also include a user interface 226 for allowing the user to interact with the distributed system 200 and/or system 202.

The system 202 may be configured to access information about a candidate webpage from other systems 220A and 220B using the network interface 214. In some embodiments, the system 202 may be configured to download the candidate webpage itself. For example, the system 202 may be configured to download a source file of a candidate webpage in a format such as HTML, XHTML, ASP, PHP, PDF, or other format. In some embodiments, the system 202 may be configured to store the contents of the source file in a database or other memory location so that they may be accessed at a later time.

In some embodiments, the system 202 may be configured to access information about the candidate webpage from a source other than the candidate webpage itself. For example, other pages accessible at the same domain or subdomain as the candidate webpage may be accessed. In some embodiments, the system 202 may be configured to access third party data sources containing information about the candidate webpage. For example, the system 202 may be configured to access the linking structure of the candidate webpage through a third party database such as the Linkscape service offered by SEOmoz of Seattle, Wash. As another example, the system 202 may be configured to access an Internet newsfeed, newswire, or database of press releases and/or news stories, which may be useful in determining whether a candidate webpage is the subject of recent news stories and thus possibly of a higher importance. If an Internet newsfeed links to the candidate webpage or a webpage on the some domain as the candidate webpage, it may be more likely that the candidate webpage is a genuine source of useful information rather than just a source of links. In another embodiment, the system 200 may be configured to access information about the registration history of the domain name through which the candidate webpage is accessible.

In other embodiments, the system 202 may be configured to access data generated about the candidate webpage by third-party analytics systems. Some third-party analytics systems may generate metrics representing the trustworthiness of a candidate webpage based on its linked proximity to known trusted webpages. Third-party analytics systems may also generate metrics representing the popularity of a candidate webpage based on the number of links to the candidate webpage from other webpages. The system 202 may be configured to store information about the candidate webpage in a database or other memory location so that they may be accessed at a later time.

The system 202 may be configured to access information about the candidate webpage directly through use of various network protocols, such as HTML. In some embodiments, the system may also be configured to access information through the use of an API 216 (Application Programming Interface) or database query.

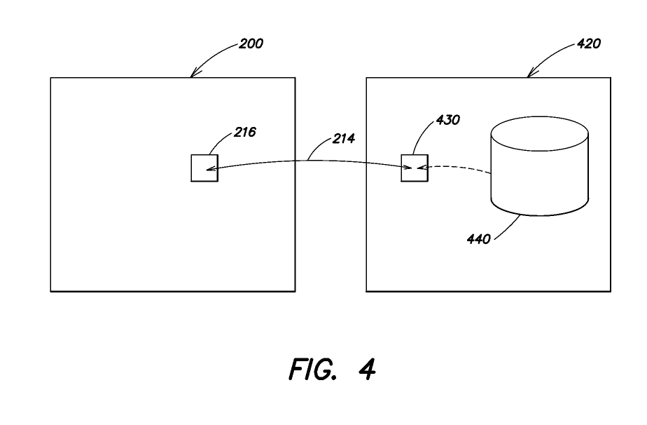

A block diagram showing an exemplary API 216 can be seen in FIG. 4. The API 216 may be an interface implemented by a software program on system 202, thereby allowing the system 202 to interact with other software on other systems 420 that may be accessed over the network interface 214. The API 216 on the other system 420 may allow the system 202 to indirectly access information stored in a database 440 on the other system 420. According to one embodiment, the API 216 may be implemented as a web service based on a protocol such as Simple Object Access Protocol (SOAP), or may be implemented on another architecture, such as a Representational State Transfer (REST) architecture.

Referring again to FIG. 2, the database 208 may be a relational database or any other method of storing data known in the art, such as XML, flat file, or spreadsheet, or other location in a computer memory. The database 208 may be a commercial database product, such as IBM DB2, Microsoft SQL Server, MySQL, Openbase, Sybase, or other database product. The database 208 may store textual information and/or binary information, and may store textual information as plain text, or may encode it in binary or other format.

The database 208 may be configured to store a blacklist 210 of keywords known or believed by search engines to be associated with low importance webpages. Some search engines (for example, Google) may “blacklist” keywords that typically appear on webpages that are intended to deceive search engines into assigning a higher importance to those webpages. For example, the creator of a webpage that would be of little use to a person interested in finding directions to a nearby casino might nonetheless repeat the word “casino” several times in the webpage in an attempt to manipulate the search engine algorithms into assigning a higher importance to the webpage. In response, search engines may be configured to penalize such low-importance webpages by assigning them a low importance. A search engine may also penalize all webpages linked from the penalized webpage, on the theory that they are probably also of limited or no importance. Therefore, it would be highly undesirable for a marketer to place a link on a penalized webpage, since the linked webpage could be devalued or assigned a lower importance simply because of that link. Therefore, in some embodiments it may be desirable to assign a low importance to or otherwise devalue those candidate webpages 292 that contain some threshold number of what are known or believed to be blacklisted keywords, for example, “casino”, “porn”, “pills” or others. In some embodiments, the blacklist 210 may be entered by a user of the user interface 226. In other embodiments, the blacklist 210 may be maintained by a system administrator or system process, and may not be accessible or visible via the user interface 226.

The database 208 may also be configured to store a competitor list 212 that identifies the webpage(s) of one or more competitors of the marketer. Identifying the competitors of the marketer may be useful in determining the importance of a candidate webpage, because the presence of links to competitor's webpages on the candidate webpage may indicate that the webpage is relevant to the subject matter of the linked webpage and therefore may be a desirable candidate for hosting a link to the linked webpage. Furthermore, it may be desirable to avoid attempting to place a link on a competitor's webpage. Consumers may become confused about the relationship between the marketer and the competitor, and presumably both parties would object to a link to the linked webpage appearing on the competitor's webpage. Therefore, while a competitor's webpage would likely be relevant, assigning it a high importance would be misleading, and the effort expended in attempting to place a link on the competitor's webpage would be wasted. Thus, the competitor list 212 may be maintained and referenced by the importance engine 204 to avoid generating an importance score for any webpage known to be associated with a competitor.

In some embodiments, the database 208 may be configured to receive input from external sources, for example, a user input device, and form that input into the information to be stored by the database 208. In other embodiments, the competitor list 212 may be maintained by a system administrator or system process, and may not necessarily be accessible or visible via the user interface 226. In still other embodiments, the competitor list 212 may be accessed or generated by a software function, for example, through a API 216 or software configured to extract data from a web page by “scraping” or other techniques known in the art.

The database 208 may also be configured to store identifiers of one or more candidate webpages 292. The candidate webpages 292 may have been identified as possible candidates for hosting a link to the linked webpage. The candidate webpages 292 may have been entered via the user interface 226, or may be maintained by a system administrator or system process, and may not necessarily be accessible or visible via the user interface 226. In some embodiments, a common list of candidate webpages 292 may be stored for all users of the system. In other embodiments, a separate list of candidate webpages 292 may be stored for each account, user, campaign, or ad group. In some embodiments, the system 202 may be configured to periodically check the list of candidate webpages 292 stored in the database 208 and flag or automatically purge those candidate webpages 292 that are non-functional or have otherwise become of little value for hosting links to a linked webpage.

The user interface 226 may be configured to receive input from a user through any number of input devices known in the art. The user input may include one or more identifiers that identify candidate webpages 292. The input may include, for example, a list of URLs of webpages. In some embodiments, the candidate webpages 292 may be entered by a user typing the webpage identifiers into a text box on a webpage. In other embodiments, the candidate webpages 292 may be provided by uploading a file that has previously been populated with an identifier (such as a URL) of the candidate webpages 292. In other embodiments, the system 202 may maintain a list of candidate webpages 292, and the user may select the candidate webpages 292 from a list.

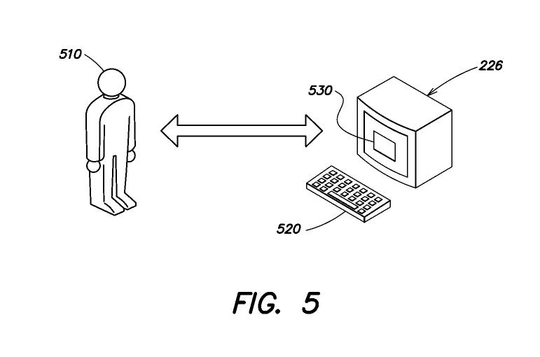

As can be seen in the block diagram of FIG. 5, the user interface 226 may allow a user 510 to interact with the user interface 226 through the use of a user input device 520. The user input device 520 may be of any type known in the art, such as a keyboard, mouse device, trackball, microphone, touch screen, printing device, or display screen. The user interface 226 may display an indication 530 in response to the input entered by the user 290. For example, the indication 530 may indicate whether the user input is valid.

In some embodiments, the user input may include one or more keywords. The keywords may be keywords that will potentially be used by users of a search engine in performing a search. Referring again to FIG. 2, webpages that have been identified to the system 202 as candidate webpages 292 may be evaluated for their importance, in part or in whole, based on their relevance to keywords entered by those users. Therefore, a marketer may wish to evaluate or predict the importance of one or more candidate webpages 292 based on keywords entered or selected by a user or the system 202. It will be appreciated that references to a “keyword” herein may refer not only to individual words, but also phrases or groups of words.

The importance engine 204 may be configured to determine the importance of one or more candidate webpages 292 according to one or more keywords and information about the candidate webpages 292 that may be accessed via the network interface 214. The importance of the one or more candidate webpages 292 may be determined with reference to the content of the candidate webpages 292. For example, the importance engine 204 may be configured to examine the content of the candidate webpage 292 and count the number of times that a keyword appears. In some embodiments, a candidate webpage 292 may be assigned a higher importance if it includes the keyword in a prominent position, for example, in the title of the candidate webpage 292 or within HTML header tags such as H1, H2, H3, or other header tags. In still other embodiments, the importance engine 204 may determine if a keyword appears in the anchor text of hyperlinks appearing on the candidate webpage 292, since it is believed that search engines refer to anchor text in determining relevance. As will be described in detail below, a variety of information about the candidate webpages 292 may be accessed from online sources via the network interface 214.

The importance engine 204 may be configured to determine a quantitative ranking of each candidate webpage 292 according to one or more keywords and information about the candidate webpages 292 that may be accessed via the network interface 214. In some embodiments, the quantitative rankings of several candidate webpages 292 may be compared, and a relative ranking of candidate webpages 292 may be determined.

The linguistic engine 206 may be configured to identify linguistic relationships between keywords and text found in the content of a candidate webpage 292. For example, a stemming algorithm may be applied to the keywords and/or the candidate webpage 292 to determine if variants of the keywords appear in the content of the candidate webpage 292. Various types of stemming algorithms are known in the art, for example, brute force algorithms, suffix-stripping algorithms such as the Porter algorithm, lemmatization algorithms, stochastic algorithms, or other algorithm types. In some embodiments, a dictionary may be provided, and the linguistic engine 206 may identify synonyms of a keyword and search for those keywords in the content of a candidate webpage 292. In some embodiments, natural language processing techniques such as latent semantic analysis may be performed. In some embodiments, the linguistic engine 206 may determine, through a character-replacement algorithm or reference to a list of common misspellings, that a keyword entered by a user is a common misspelling of a known word. The linguistic engine 206 may cause the system 202 to identify occurrences of the correctly-spelled keyword in the content of a candidate webpage 292. In some embodiments, a reading level of the candidate webpage may be determined through any of a number of algorithms known in the art, including the Dale-Chall Readability Formula, the Flesch-Kincaid readability tests, the Gunning-Fog Index, or others.

The linguistic engine 206 may be configurable to operate in one of several languages. For example, the system 202 may allow the user to select a language, and, responsive to that selection, perform stemming and language analysis in that selected language.

### Exemplary Method

Having described various aspects of a system for evaluating link-hosting webpages, the operation of such a system is now described.

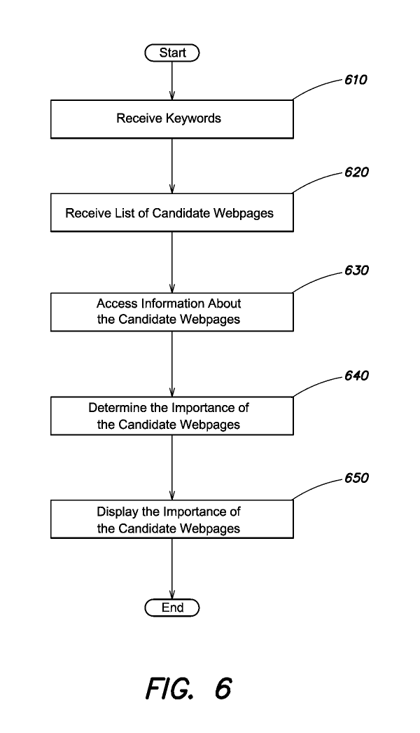

A method according to one embodiment of the invention is described with reference to FIG. 6.

In act 610, one or more keywords are received on a computer system. In some embodiments, the keywords may be typed or entered by a user into a user interface or input file. In some embodiments, the user may be allowed to enter a phrase as a keyword. For example, the user may identify a phrase by surrounding multiple keywords with quotation marks. The user may be permitted to enter multiple keywords using delimiters or other techniques known in the art for delineating individual pieces of text. For example, the user may type one keyword or phrase per line, or may separate keywords or phrases with a predefined delimiter such as a comma (“,”), semicolon (“;”), or vertical bar (“|”). In other embodiment, a list of keywords may be presented to a user of a user interface, and the user may be permitted to select one or more keywords. The keywords may be temporarily stored in a memory location of the computer system to be referenced in later acts, or they may be stored in a database such as the type described above with reference to FIG. 2.

In act 620, one or more identifiers of candidate webpages are received on the computer system. The candidate webpages may have been previously identified as actual or potential hosts for a link to a linked webpage. In some embodiments, the identifier may be a full URL of a webpage. In other embodiments, the identifiers may be domain names or hostnames. In some embodiments, the identifiers may be typed or entered by a user into a user interface or input file. In some embodiments, the user may be allowed to enter a phrase as a keyword. For example, the user may identify a phrase by surrounding multiple keywords with quotation marks. The user may be permitted to enter multiple keywords using delimiters or other techniques known in the art for delineating individual pieces of text. For example, the user may type one keyword or phrase per line, or may separate keywords or phrases with a predefined delimiter such as a comma (“,”), semicolon (“;”), or vertical bar (“|”). In other embodiment, a list of keywords may be presented to a user of a user interface, and the user may be permitted to select one or more keywords. The keywords may be temporarily stored in a memory location of the computer system to be referenced in later acts, or they may be stored in a database such as the type described above with reference to FIG. 2.

In act 630, information about the webpages identified in act 620 is accessed over a computer network (e.g., the Internet), and in act 640, the importance of the candidate webpage is determined based on the keyword and the information about the candidate webpage accessed in act 630. Various pieces of information about the candidate webpage may be obtained, both from the candidate webpage and from other sources. The importance of the candidate webpage may be determined by aggregating these various pieces of information according to any number of mathematical or statistical functions or algorithms known in the art.

In some embodiments, it may be determined if the candidate webpage still exists and would load in a web browser without an error. It may also be determined if the candidate webpage is configured to automatically redirect to another webpage. The webpage itself may be downloaded over the computer network. For example, the webpage may be a file in the format of HTML, XHTML, DHTML, PHP, ASP, or other format, and the contents of that file may be downloaded using a protocol such as HTTP, HTTPS, FTP, or other protocol. In some embodiments, the content of the candidate webpage may be examined to determine the existence, location, and frequency of the keywords in the candidate webpage. For example, it may be determined whether and how often the keyword appears in the URL of the candidate webpage. Similarly, it may be determined whether and how often the keyword appears in certain hierarchical HTML tags, such as the <TITLE> tag, <H1> or other header tag, image ALT tag, meta description tag, or anchor text of internal or external links found in the candidate webpage. In some embodiments, a stemming algorithm (such as one or more of those discussed above in reference to FIG. 2) may be performed on the keywords and/or the content of the candidate webpage, and variants of keywords appearing on the candidate webpage may be counted in addition to or separately from exact occurrences of keywords. In some embodiments, the frequency with which the keywords appear in the content of the candidate webpage may be determined by normalizing the number of occurrences of the keyword with respect to the amount of content on the candidate webpage.

In some embodiments, the content of the candidate webpage may be examined to identify certain linguistic occurrences. For example, the number or percentage of misspelled words on the candidate webpage may be determined. In some embodiments and as described above with respect to FIG. 2, the candidate webpage may be examined to identify one or more blacklist keywords.

In some embodiments, the entropy of the candidate webpage may be determined. As used herein, “entropy” is a measure of the variety of words appearing on a webpage. Thus, entropy may be used to determine whether the candidate webpage is focused on a single topic, or, alternatively, lacks focus or focuses on several unrelated topics. Search engines may use such information to determine the strength of a webpage, on the theory that a page having content on a wide variety of topics is of a low relevance to any individual topic. Search engines may therefore assign a low importance to such webpages. Thus, a link from a page that is highly focused on a particular topic may be more valuable for ranking purposes than a link from a page that contains content on a wide variety of topics.

The number and type of media appearing on the candidate webpage may be determined. For example, the content of the candidate webpage may be examined for tags that would indicate certain media types, such as audio, video, still images, Macromedia Flash, or other media type are embedded or otherwise present in the candidate webpage. Candidate webpages having a higher number or variety of media types may alternately be assigned a higher or lower importance, on the theory that the organization is more or less likely to be receptive to a request to placing a link on the candidate webpage.

Similarly, the number and type of advertisements on the candidate webpage may be determined. Candidate webpages having a higher number of advertisements, or advertisements about a certain type or category of product, may be indicative that the candidate webpage is merely a commercial venture for hosting advertisements, and thus of a low strength or relevance.

In some embodiments, information about links to and from the candidate webpage may be accessed over a computer network. For example, the candidate webpage may be examined to determine if a link to the linked webpage already exists. Furthermore, information about the linking structure of a network such as the Internet can be determined. This information may be accessible through a third party data source, such as the Linkscape application offered by SEOMoz, or may be derived by the system itself. It may be possible, for example, to determine the number of links on external webpages that point to the candidate webpage. Similarly, it may be possible to determine the number of links on external webpages that point to the domain or subdomain of the candidate webpage.

In some embodiments, rankings and scores previously assigned to the candidate webpage by ranking entities and/or applications may be accessed over the computer network. For example, a ranking entity may have assigned a “trust” score to the candidate webpage. The trust score of a candidate webpage may be a keyword-independent value based on the external webpages that point to the candidate webpage or its domain. For example, a candidate webpage that is linked to from several known reputable webpages may be presumed to be a trusted webpage. On the other hand, a candidate webpage that is linked to only by unknown or disreputable webpages, such as those associated with spammers, may be assigned a low trust score by a ranking entity. Similarly, a ranking entity may have assigned an “authority” score to the candidate webpage. The authority score of a candidate webpage may be a keyword-independent value based on the number and quality of links on external webpages that point to the candidate webpage or its domain. For example, a candidate webpage that is linked to by several external webpages may be presumed to be an authority on its particular topic due to its popularity.

Such ranking scores may be available on a subscription, paid, and/or free basis, and may be available for download via FTP, HTTP, or other protocol from third parties such as ranking entities. In some embodiments, ranking scores may be accessible through use of a software API. Several ranking scores are known in the art and provided by commercial entities. The ranking scores may be provided for both the specific candidate webpage as well as the domain of the candidate webpage. For example, seoMoz's Linkscape service offers rankings including Page mozRank (similar to the concept of Google's PageRank), Domain mozRank, Page mozTrust, and Domain mozTrust. Aggregate scores that combine one or more rankings on different factors may be available. For example, the Linkscape tool provides an importance-like ranking called Domain Authority that is an aggregation of Domain mozRank, Domain is mozTrust, and other factors.

Other information may be obtained over the network from other sources. For example, information about the registration status of the domain name associated with the candidate webpage may be accessed from a domain registration service, such as WHOIS. Information such as the “age” of the domain registration (i.e., the amount of time since the domain was first registered to the present owner) may be determined Likewise, the amount of time remaining until the domain name registration expires may be determined. This information may be useful because search engines may assign a higher importance to webpages at domains that have been or will be registered for a relatively long time. Webpages created for the purpose of hosting only advertisements are often registered for very short periods of time, such as a year or less. Therefore, a webpage that is registered for a longer period of time is less likely to be penalized by search engines for only hosting advertisements.

Other data sources may be accessed to obtain information about the candidate webpage. For example, a newswire or other service may be referenced to determine when the most recent press release referencing the candidate webpage was accessed.

In some embodiments, parameters associated with links to the candidate webpage from external webpages may be examined. Links to the candidate webpage that are deprecated or otherwise indicated to be of low or unknown importance may then be disregarded. For example, external links to the candidate webpage may be accessed to determine if they have been assigned the HTML attribute value of nofollow, which may be used by site administrators to request that search engines not rank a webpage based on the nofollow links on that webpage.

In some embodiments, other attributes of the candidate webpage may be examined. For example, the content of the candidate webpage may be examined to identify the most recent date that appears in the content. An algorithm to identify common date formats may be employed. In other embodiments, the date that the candidate webpage was last updated may be determined. In some embodiments, the date that the homepage of the candidate webpage was last updated may be determined. The homepage may be recognized by identifying in the same directory as the candidate webpage a file satisfying home page naming conventions, such as index.html or home.php.

In other embodiments, information that would help to categorize the candidate webpage may be accessed. In some embodiments, the URL or the content of the candidate webpage may be parsed to determine the type of the candidate webpage. It may be possible to determine from the URL or the content whether the candidate webpage is on a social networking site, or is a blog, a web discussion forum, or a dedicated link-hosting page. For example, the URL of the candidate webpage may be parsed for the substring “blogspot.com” If such a substring is found, it may be determined that the candidate webpage is a blog hosted by Blogger.com. Similarly, the content of the webpage may be inspected for information, including metadata, header text, footer text, or other text or information that indicates the category of the webpage.

In some embodiments, information about the feasibility of obtaining a link may be determined. For example, the URL may also be examined to estimate the likelihood that a link could be placed on the candidate webpage. If it is determined that the candidate webpage is located within the top-level domain “.gov”, it would be known that placing a link on the candidate webpage would be unfeasible and therefore unlikely. In some embodiments, the content of the candidate webpage or metadata stored in or with the candidate webpage may be used to make such a determination.

The importance of the candidate webpage may be determined by normalizing the information described above. For example, an excessive number or percentage of misspelled words on the candidate webpage may cause the candidate webpage to be assigned a lower importance, on the theory that a candidate webpage with several misspelled words is probably not a quality webpage and will likely be regarded poorly by a search engine. Similarly, it can be predicted that a candidate webpage containing blacklisted words will be deprecated or penalized by a search engine.

The age of the domain registration may also be normalized as part of determining the importance. For example, it may be known in the art that webpages that are associated with a new domain are likely to contain content that will be assigned low importance by a search engine, whereas mature domains are more likely to contain content of higher importance. Similarly, it may be predicted that a domain that is registered for a shorter amount of time (such as one year) is more likely to contain low-importance content than a domain that is registered for a longer period of time (such as 10 years).

Candidate webpages may be assigned a higher importance by search engines when they are updated frequently, or when the candidate webpages are mentioned in recent press releases. Thus, the importance of the candidate webpage may be determined with reference to the amount of time since the most recent update to the candidate webpage, or the amount of time since the most recent press release mentioning the candidate webpage.

A quantitative value of the importance of each candidate webpage may be determined. In some embodiments, the quantitative rankings of multiple candidate webpages may be compared, and a relative ranking of candidate webpages may be determined.

In act 650, the importance of the candidate webpages may be displayed on a computer-based user interface. A list of candidate webpages may be displayed. In some embodiments, importance information about all candidate webpages is displayed. In other embodiments where the list of candidate webpages is ranked, only information about a limited number of candidate webpages may be displayed, where the candidate webpages displayed have been identified as the most important candidate webpages according to one or more factors. The individual factors and measurements described above may be displayed, and in some embodiments, an overall importance score or value may be displayed. As will be described in more detail below, the user may be provided the opportunity to customize the list of the candidate webpages, and may be provided functionality to sort, display, and/or hide some fields.

### User Interfaces

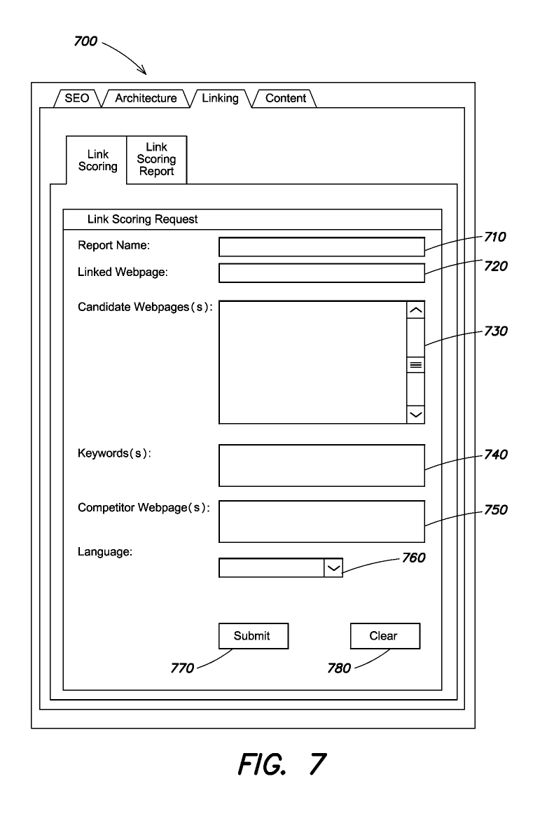

FIG. 7 shows an exemplary input interface 700 for entering information relevant to evaluating a link-hosting webpage in accordance with one aspect of the present invention. A report name field 710 may be provided to allow a user to provide a report name for the link-scoring report that will be generated. The input interface 700 may enforce predefined or used-defined rules regarding the name of the report, and may be configured to allow, disallow or require certain special characters or substrings in the report name. In some embodiments, the input interface may also include a linked webpage field 720 to allow the user to provide the URL or other identifier of the webpage that will be the linked webpage if a link is placed on a candidate webpage. This information will allow the system to identify useful information, for example, if a link to the linked webpage already exists on the candidate webpage.

The input interface 700 may also include a candidate webpage field 730 to allow the user to provide a list of candidate webpages. The field may be configured to receive URLs or other identifiers of the candidate webpages.

The input interface 700 may also include a keyword field 740 to allow the user to to provide a list of keywords. The keywords may be used to predict the relevance that would be attributed to a particular candidate webpage by a search engine in response to a search engine query on the keywords.

The input interface 700 may also include a competitor webpage field 750 to allow the user to provide a list of URLs of the webpages of competitors of the marketer. By identifying competitors of the marketer, the system can identify candidate webpages that link to those competitors. These candidate webpages may be assumed to be relevant. Furthermore, the system can identify those candidate webpages that are associated with a competitor, and assign an importance to those webpages that reflects the unlikelihood of a competitor hosting a link to the marketer's webpage.

The input interface 700 may also include a language field 760 to allow the user to select a language the system should use to perform linguistic analysis, stemming, or other language-specific aspects of evaluating a link-hosting webpage.

When more than one item is provided in a given input field as described above, the items may be separated be a delimiter such as a comma (“,”), a semicolon (;), a carriage return, or other delimiter.

The input interface 700 may also include a submit button 770 to allow a user of the interface to submit the data entered in the various fields described above, and cause the system to determine the importance of the one or more candidate webpages entered in candidate webpage field 730 based on the keywords entered in the keyword field 740 and the other input choices made by the user. A clear button 780 may also be provided such that, when it is clicked, any input entered or selected by the user is cleared from the input interface 700.

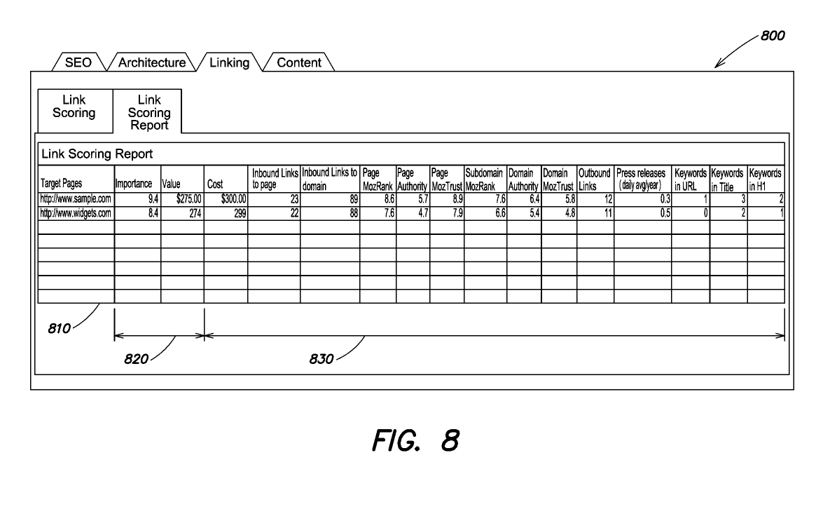

FIG. 8 shows an exemplary reporting interface 800 for organizing and displaying the result of the evaluation of one or more link-hosting webpages. The reporting interface 800 may display a table of candidate webpages 810, along with an importance value 820 for the candidate webpages that were analyzed. In some embodiments, the importance may be represented as a numerical score within a certain range, for example, a score on a scale of 0 to 10. In other embodiments, the importance may be represented as a sum or other function of the various metrics calculated to determine the importance of each candidate webpage. In some embodiments, the importance may in addition or in the alternative be represented as a dollar value. This value may represent the cost that a marketer can expect to expend to place a link on that candidate webpage, or it may represent an optimal cost for the marketer to expend based on the marketer's expected profit, revenue, return on investment, or other indicator.

The reporting interface 800 may also display one or more of the metrics 830 described above calculated for each candidate webpage 810. The reporting interface 800 may also include information about the current status of the marketer's relationship with the candidate webpage, for example, whether the candidate webpage currently hosts a link to the marketer's webpage, and if so, what cost the marketer has expended to place or maintain the link during a given time period.

The reporting interface 800 may provide controls to allow a user to sort the results by the value of any of the metrics 830. The reporting interface 800 may also allow the user to configure whether a particular metric is displayed or hidden to the user.

The input interface 700 and the reporting interface 800 are provided for exemplary purposes, and different configurations of data may be displayed and different statistical methods may be performed in other embodiments. Further, some or all of the interfaces may be incorporated into a software suite or package.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms. Furthermore, it will be appreciated that the systems and methods disclosed herein are not limited to any particular application or field, but will be applicable to any endeavor wherein a value is apportioned among several placements.

Where technical features in the drawings, detailed description or any claim are followed by references signs, the reference signs have been included for the sole purpose of increasing the intelligibility of the drawings, detailed description, and claims. Accordingly, neither the reference signs nor their absence are intended to have any limiting effect on the scope of any claim placements.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

What is claimed is:

1. A method for valuing a link-hosting webpage, the method including acts of:
receiving, on a computer system, at least one keyword;
receiving, on a computer system, at least one identifier of a webpage, the webpage having been previously identified as a link-hosting webpage;
accessing information about the webpage over a computer network;
determining an importance of the webpage based on the at least one keyword and the information about the webpage; and
displaying the importance on a computer-based user interface.

2. The method of claim 1, wherein the acts of receiving, on the computer system, the at least one keyword and the at least one identifier of the webpage includes an act of receiving user input from a user through a computer-based user interface.

3. The method of claim 1, wherein the act of accessing information about the webpage over the computer network includes an act of accessing, through an application programming interface, information about the webpage from a third party database.

4. The method of claim 1, wherein the act of determining the importance of the webpage based on the at least one keyword and the information about the webpage includes an act of counting a number of occurrences of the at least one keyword on the webpage.

5. The method of claim 4, wherein the act of determining the importance of the webpage based on the at least one keyword and the information about the webpage further comprises acts of:
reducing each of the at least one keywords to a first word stem;
identifying at least one word within the webpage;
reducing the at least one word to a second word stem; and
responsive to the first word stem and the second word stem being substantially identical, identifying the second word stem as an occurrence of the at least one keyword.

6. The method of claim 4, wherein the act of determining the importance of the webpage based on the at least one keyword and the information about the webpage includes an act of identifying a number of occurrences of the at least one keyword within a title tag on the webpage.

7. The method of claim 1, wherein the act of accessing information about the webpage over a computer network includes an act of accessing registration information about a domain where the webpage is hosted.

8. The method of claim 1, wherein the act of determining the importance of the webpage based on the at least one keyword and the information about the webpage includes an act of generating a quantitative importance score for the webpage.

9. The method of claim 1, wherein the act of determining the importance of the webpage based on the at least one keyword and the information about the webpage includes an act of estimating a value of a link on the webpage.

10. The method of claim 9, wherein the value of the link is calculated based on the similarity of the candidate webpage to at least one host webpage that has hosted another link, where the value of the another link is known.

11. The method of claim 9, wherein the value of the link is a numerical score.

12. The method of claim 9, wherein the value of the link is a dollar value.

13. The method of claim 1, wherein the act of receiving, on a computer system, at least one identifier of a webpage comprises the act of receiving a first identifier of a first webpage and a second identifier of a second webpage, further comprising acts of:
accessing information about the first webpage and the second webpage over the computer network;
determining a comparative importance of the first webpage and the second webpage based on the at least one keyword and the information about the first webpage and the second webpage; and
displaying the comparative importance on the computer-based user interface.

14. The method of claim 1, further comprising an act of receiving, on a computer system, at least one identifier of a competitor webpage, wherein the act of accessing information about the webpage over the computer network includes the act of comparing the at least one identifier of the competitor webpage to the at least one identifier of the webpage, and wherein the act of accessing information about the webpage over a computer network is performed responsive to the at least one identifier of the competitor webpage not matching the at least one identifier of the webpage.

15. The method of claim 1, wherein the act of determining the importance of the webpage based on the at least one keyword and the information about the webpage includes an act of identifying a number of occurrences of the at least one keyword within a URL of the webpage.

16. The method of claim 1, wherein the act of determining the importance of the webpage based on the at least one keyword and the information about the webpage includes an act of identifying a number of different media formats on the webpage.

17. The method of claim 1, wherein the act of determining the importance of the webpage based on the at least one keyword and the information about the webpage includes an act of determining an amount of time that has elapsed since the webpage was last changed.

18. The method of claim 1, further comprising acts of:
receiving, on a computer system, at least one blacklist keyword, the at least one blacklist keyword having been previously associated with a low importance;
counting a number of occurrences of the at least one blacklist keyword on the webpage; and
wherein the act of determining the importance of the webpage based on the at least one keyword and the information about the webpage includes an act of identifying a number of occurrences of the at least one blacklisted keyword on the webpage.

19. The method of claim 1, wherein the act of determining the importance of the webpage based on the at least one keyword and the information about the webpage includes an act of identifying a reading level of textual content on the webpage.

20. The method of claim 1, wherein the act of determining the importance of the webpage based on the at least one keyword and the information about the webpage includes acts of:
identifying at least one content topic on the webpage; and
for each content topic, determining whether the content topic is relevant to the keyword.

21. The method of claim 1, wherein the act of determining the importance of the webpage based on the at least one keyword and the information about the webpage includes an act of identifying advertisements on the webpage.

22. The method of claim 1, wherein the act of determining the importance of the webpage based on the at least one keyword and the information about the webpage includes an act of identifying a category substring within a URL of the webpage, the category substring identifying a category for the website.

23. The method of claim 1, wherein the act of determining the importance of the webpage based on the at least one keyword and the information about the webpage includes an act of identifying a category substring within the webpage, the category substring identifying a category for the website.

24. The method of claim 1, wherein the act of determining the importance of the webpage based on the at least one keyword and the information about the webpage includes an act of determining a duration of time for which a domain name of the webpage has been registered.

25. The method of claim 1, wherein the act of determining the importance of the webpage based on the at least one keyword and the information about the webpage includes an act of determining a term for which a domain name of the webpage has been registered.

26. The method of claim 1, further comprising an act of identifying in the webpage a telephone number associated with the webpage.

27. The method of claim 1, further comprising an act of identifying in the webpage an email address associated with the webpage.

28. The method of claim 1, wherein the webpage is a first webpage, further comprising acts of:
identifying a press release webpage that contains hyperlinks to at least one press release; and
identifying, on the press release webpage, a hyperlink to a press release associated with the first webpage.

29. The method of claim 1, wherein the act of determining the importance of the webpage based on the at least one keyword and the information about the webpage includes an act of determining a prominence of the at least one keyword within the content of the webpage.

30. The method of claim 29, wherein the act of determining the prominence of the at least one keyword is determined with reference to a term frequency-inverse document frequency.

31. The method of claim 29, wherein the prominence is determined through latent semantic analysis.

32. The method of claim 29, wherein the prominence is determined through latent Dirichlet allocation.

33. The method of claim 1, wherein the act of determining the importance of the webpage based on the at least one keyword and the information about the webpage includes an act of identifying a number of occurrences of the at least one keyword in an HTML tag.

34. The method of claim 33, wherein the HTML tag is a title tag.

35. The method of claim 33, wherein the HTML tag is a meta description tag.

36. The method of claim 33, wherein the HTML tag is an image ALT tag.

37. A method for evaluating the importance of a link-hosting webpage, the method including acts of:
receiving, on a computer system, at least one keyword;
receiving, on a computer system, at least one identifier of a webpage;
accessing information about the webpage over a computer network;
predicting, based on the at least one keyword and the information about the webpage, an importance that would be attributed to the webpage by a search engine performing a search on the at least one keyword; and
displaying the importance on a computer-based user interface.

38. A system comprising:
a user interface configured to receive at least one keyword and an identifier of a webpage, and further configured to display an importance of the webpage;
a network interface configured to access information about the webpage over a computer network; and
an importance engine configured to determining the importance of the webpage based on the at least one keyword and the information about the webpage.

39. A computer-readable medium comprising computer-executable instructions that, when executed on a processor of a server, perform a method for valuing a link-hosting webpage, comprising acts of:
receiving, on a computer system, at least one keyword;
receiving, on a computer system, at least one identifier of a webpage, the webpage having been previously identified as a link-hosting webpage;
accessing information about the webpage over a computer network;
determining an importance of the webpage based on the at least one keyword and the information about the webpage; and
displaying the importance on a computer-based user interface.
